(19) United States
(12) Patent Application Publication
(10) Pub. No.: US 2026/0058469 A1
(43) Pub. Date: Feb. 26, 2026

(54) MICROGRID COMMAND STRATEGY

(71) Applicant: Caterpillar Inc., Peoria, IL (US)

(72) Inventors: Ranjay SINGH, Kanpur (IN); Manoj Kumar BANTUPALLI, Vizianagaram (IN); Srideep CHATTERJEE, Bhopal (IN); Sowmya NAGESH, Peoria, IL (US)

(73) Assignee: Caterpillar Inc., Peoria, IL (US)

(21) Appl. No.: 18/810,984

(22) Filed: Aug. 21, 2024

(51) Int. Cl. H02J 3/28; H02J 3/38; H02J 7/00

(52) U.S. Cl. CPC H02J 3/28; H02J 3/38; H02J 7/00712

(57) ABSTRACT

A microgrid controller of a microgrid includes a communication interface configured to receive load information corresponding to a plurality of loads connected to the microgrid, receive energy resource information corresponding to a plurality of energy resource systems connected to the microgrid, and output control signals for controlling an operation of each energy resource system; and one or more processors configured to perform at least two dispatch operations selected from a load balance dispatch operation, an export dispatch operation, or a charge/discharge dispatch operation according to a prioritization dispatch scheme. The load balance dispatch operation, the export dispatch operation, and the charge/discharge dispatch operation are assigned different dispatch priorities that define a sequence of dispatch operations of the prioritization dispatch scheme. The plurality of energy resource systems includes energy storage systems (ESSs), unidirectional non-ESSs, and bidirectional non-ESSs.

### TECHNICAL FIELD

The present disclosure relates generally to microgrids and, for example, to a microgrid controller configured to control or manage an operation of a microgrid.

### BACKGROUND

A microgrid is a self-sufficient energy system that serves a particular geographic area, such as a college campus, a hospital complex, a business center, a neighborhood, a mining site, a drilling site, and/or the like. Within a microgrid are one or more kinds of distributed energy resources (DERs) (e.g., solar panels, wind turbines, fuel cells, photovoltaic (PV) cells, generators, energy storage devices (e.g., batteries, capacitors), and/or other energy sources) that produce power for the microgrid. Some microgrids are configured as off-grid electrical power distribution systems (e.g., stand-alone microgrids or islands) that do not connect to a larger electrical power distribution system (e.g., a macrogrid) run by, for example, an electric utility or power plant. Some microgrids are able to operate in a grid-connected mode and in a stand-alone mode. In a grid-connected mode, a microgrid may operate connected to and synchronous with the larger electrical power distribution system. In a stand-alone mode, the microgrid may be disconnected from the larger electrical power distribution system and operate as a stand-alone microgrid. A microgrid controller may control whether the microgrid operates in the grid-connected mode or in the stand-alone mode, for example, based on a schedule or based on one or more conditions being satisfied.

A microgrid may have a number of different types of energy resource systems that supply power to the microgrid to operate one or more loads, including energy storage type systems (e.g., energy storage system (ESS) assets) and non-energy-storage type systems (e.g., non-ESS assets). Energy storage type systems may be charged and discharged. Thus, energy storage type systems may be bidirectional assets that act as sources or sinks within the microgrid.

Additionally, non-energy-storage type systems may be unidirectional or bidirectional. A unidirectional non-energy-storage type system can only supply power to the microgrid. A bidirectional non-energy-storage type system can both supply power to the microgrid and absorb power from the microgrid. Thus, a unidirectional non-energy-storage type system can only act as a source, whereas a bidirectional non-energy-storage type system can act as a source or a sink.

In current microgrids, charging or discharging of ESS assets using multiple non-ESS assets with charge restrictions is complex and has not been addressed by available microgrid controllers. A charge restriction may be placed on a non-ESS asset when the non-ESS asset is not permitted to charge a particular ESS asset or a group of ESS assets. Moreover, each non-ESS asset may have a different set of charge restrictions, such that each charge restriction may be linked to a different ESS asset or a different group of ESS assets. Thus, charge restrictions may increase a complexity of dispatching non-ESS assets for charging ESS assets. In addition, some non-ESS assets may have no charge restrictions.

Further adding to a complexity of dispatching energy resource assets, export restrictions may be placed on non-ESS assets or ESS assets. An export restriction may be placed on a non-ESS asset or an ESS asset when the non-ESS asset or the ESS asset is not permitted to export power to a particular bidirectional non-ESS asset.

Additional asset dispatch complexity may arise when different priorities are desired (based on application or scheduling) for supplying excess energy to bidirectional assets (acting as sink), importing energy from bidirectional assets (acting as source), or a hybrid approach where some bidirectional assets may act as source and other bidirectional assets may act as sink. The complexity of carrying out different prioritization dispatch schemes is compounded by specific charge and export restrictions. Put another way, command strategy complexity further increases with energy resource assets having specific charge and/or export restrictions.

European Patent Application EP2869423A1 discloses a method and apparatus for controlling power distribution within a microgrid. The microgrid described in EP2869423A1 comprises a power source module, a power storage module, and a load module. The power storage module may operate as a further power source and a power store. The load module may receive power from the power source module and the power storage module. The method of EP2869423A1 includes providing predefined modes of operation for the microgrid, each mode specifying an operational mode for one or more of the microgrid modules; receiving one or more signals, each signal specifying operational parameters of the microgrid modules; using the received signals, selecting a mode of operation for the microgrid; and controlling the microgrid modules such that they operate as specified in the selected mode of operation.

However, EP2869423A1 does not provide a command strategy for dispatching non-ESS assets with charge restrictions for ESS assets and/or export restrictions for bidirectional non-ESS assets. Moreover, EP2869423A1 does not provide a command strategy for operating a microgrid with unidirectional and bidirectional assets by configuring operations including one or more of load balancing, charging/discharging, and exporting according to a prioritization dispatch scheme.

The microgrid controller of the present disclosure solves one or more of the problems set forth above and/or other problems in the art.

### SUMMARY

In some implementations, a microgrid controller of a microgrid includes a communication interface configured to receive load information corresponding to a plurality of loads connected to the microgrid, receive energy resource information corresponding to a plurality of energy resource systems connected to the microgrid, and output control signals for controlling an operation of each energy resource system of the plurality of energy resource systems, wherein the plurality of energy resource systems includes a plurality of ESSs configured to be charged and discharged, and a plurality of non-ESSs, including a plurality of unidirectional non-ESSs configured to supply power to the microgrid, and a plurality of bidirectional non-ESSs configured to supply power to the microgrid or absorb power from the microgrid; and one or more processors configured to perform at least two dispatch operations selected from a load balance dispatch operation, an export dispatch operation, or a charge/discharge dispatch operation according to a prioritization dispatch scheme, wherein the load balance dispatch operation, the export dispatch operation, and the charge/discharge dispatch operation are assigned different dispatch priorities that define a sequence of dispatch operations of the prioritization dispatch scheme.

In some implementations, a microgrid controller of a microgrid includes a communication interface configured to receive load information corresponding to a plurality of loads connected to the microgrid, receive energy resource information corresponding to a plurality of energy resource systems connected to the microgrid, and output control signals for controlling an operation of each energy resource system of the plurality of energy resource systems, wherein the plurality of energy resource systems includes a plurality of ESSs configured to be charged and discharged, and a plurality of non-ESSs, including a plurality of unidirectional non-ESSs configured to supply power to the microgrid, and a plurality of bidirectional non-ESSs configured to supply power to the microgrid or absorb power from the microgrid; and one or more processors configured to perform at least one dispatch operation, including a load balance dispatch operation, wherein performing the load balance dispatch operation includes: evaluating priority information defining priority levels for the plurality of non-ESSs, wherein each non-ESS is assigned a different priority level, evaluating a respective power operating level for each non-ESS, calculating a total load or a remaining total load based on the load information, and distributing the total load or a remaining total load among the plurality of non-ESSs based on the priority levels and respective power operating levels of the plurality of non-ESSs such that the plurality of non-ESSs are dispatched from a highest priority level to a lowest priority level in accordance with the respective power operating levels.

In some implementations, a control method includes receiving, by a microgrid controller of a microgrid, load information corresponding to a plurality of loads connected to the microgrid; receiving, by the microgrid controller, energy resource information corresponding to a plurality of energy resource systems connected to the microgrid, wherein the plurality of energy resource systems includes a plurality of ESSs configured to be charged and discharged, and a plurality of non-ESSs, including a plurality of unidirectional non-ESSs configured to supply power to the microgrid, and a plurality of bidirectional non-ESSs configured to supply power to the microgrid or absorb power from the microgrid; assigning, by the microgrid controller, different dispatch priorities to a plurality of dispatch operations that define a sequence of dispatch operations of a prioritization dispatch scheme; wherein the plurality of dispatch operations include at least two dispatch operations selected from a load balance dispatch operation, an export dispatch operation, or a charge/discharge dispatch operation, wherein the load balance dispatch operation, the export dispatch operation, and the charge/discharge dispatch operation are assigned the different dispatch priorities that define the sequence of dispatch operations of the prioritization dispatch scheme; and generating, by the microgrid controller, control signals for controlling the plurality of energy resource systems based on the prioritization dispatch scheme.

### BRIEF DESCRIPTION OF THE DRAWINGS

FIG. 1 shows a system according to one or more implementations.

FIG. 2 shows a microgrid according to one or more implementations.

FIG. 3 shows a table showing different prioritization dispatch schemes, each having a different sequence of dispatch operations.

FIG. 4 shows a control table for charge restrictions.

FIG. 5 shows a control table for export restrictions.

FIG. 6 shows a processing system of a microgrid controller configured for performing a sequence of dispatch operations.

FIG. 7 is a flowchart of an example process associated with microgrid command strategy.

FIG. 8 is a diagram of example components of the microgrid controller associated with a microgrid command strategy.

### DETAILED DESCRIPTION

This disclosure relates to a power distribution system, and is applicable to any system that distributes and/or receives power via a power grid. Some aspects relate to a microgrid controller that is configured to control one or more components and/or systems associated with the microgrid, including energy resource systems and/or loads. The microgrid controller may control a state of the microgrid based on one or more conditions being satisfied.

A command strategy is provided for commanding microgrid assets to perform load balancing, charging/discharging of ESS type assets according to charge restrictions, and exporting to bidirectional non-ESS assets according to export restrictions. Typically, a microgrid includes two types of assets. One type of asset includes non-energy-storage systems (non-ESS), such as intermittents, gensets, utilities, fuel cells, wind turbines, and PV cells. Some non-ESS assets, such as intermittents and gensets, can be unidirectional. Other non-ESS assets, such as fuel cells and PV cells, can be bidirectional. A macrogrid or utility may also be considered to be a type of bidirectional non-ESS asset that is connected to a microgrid. Another type of asset includes energy storage systems (ESS), such as batteries, capacitors, and fly wheels. ESS assets can be charged, discharged, and/or idled, and therefore are also considered to be bidirectional assets that can act as energy sources or sinks. In particular, unidirectional assets act as sources to support loads, charging of ESS assets, and exporting to bidirectional non-ESS assets. Bidirectional assets act as both sources and sinks, which may occur serially (one at a time) or in parallel (simultaneously). While acting as a sink, a bidirectional asset may absorb power from one or more other source assets and/or one or more smart loads.

A sequence for performing different dispatch operations, such as a load balance dispatch operation, an export dispatch operation, or a charge/discharge dispatch operation can be prioritized and reordered by an operator using a human-machine interface (HMI). Put another way, an operator may define a sequence of dispatch operations of a prioritization dispatch scheme that includes one or more different types of dispatch operations. Alternatively, the sequence of dispatch operations of a prioritization dispatch scheme may be defined by a schedule in which different sequences of dispatch operations may be defined based on time of day, week, month, and/or year. The load balance dispatch operation, the export dispatch operation, and the charge/discharge dispatch operation may be assigned different dispatch priorities that define a sequence of dispatch operations of the prioritization dispatch scheme. The dispatch priorities may be provided to the microcontroller by the operator and/or according to the schedule. Thus, the prioritization dispatch scheme is entirely configurable and reconfigurable.

After having various inputs like sequence of operation, charge restrictions, export restrictions, load, current SOC, and/or various operating levels of each asset, the microgrid controller may evaluate different asset type dispatches at each and every stage of the sequence of dispatch operations. The microgrid controller may evaluate (or revaluate) a final dispatch of assets after the last dispatch operation in the sequence prior to sending final dispatch commands to the energy resource assets. Thus, the microgrid controller may execute a command strategy for dispatching unidirectional and bidirectional assets with restrictions to perform a sequence of dispatch operations in accordance with the prioritization dispatch scheme. Some sequences of dispatch operations may include load balance→charge/discharge→export; export→charge/discharge→load balance; load balance→export→charge/discharge; export→load balance→charge/discharge; load balance→charge/discharge→none; load balance→export→none; export→load balance→none; and/or load balance→none→none.

A microgrid control dispatch strategy described herein may be compatible with a power management scheme that is based on a user-defined sequence of load, export, and charging priorities; charge restrictions and hybrid charge restrictions on power sources (non-ESS type) to feed power sources (ESS type); and export restrictions and hybrid export restrictions on power sources (non-ESS or ESS type) to feed bidirectional power sources (non-ESS type).

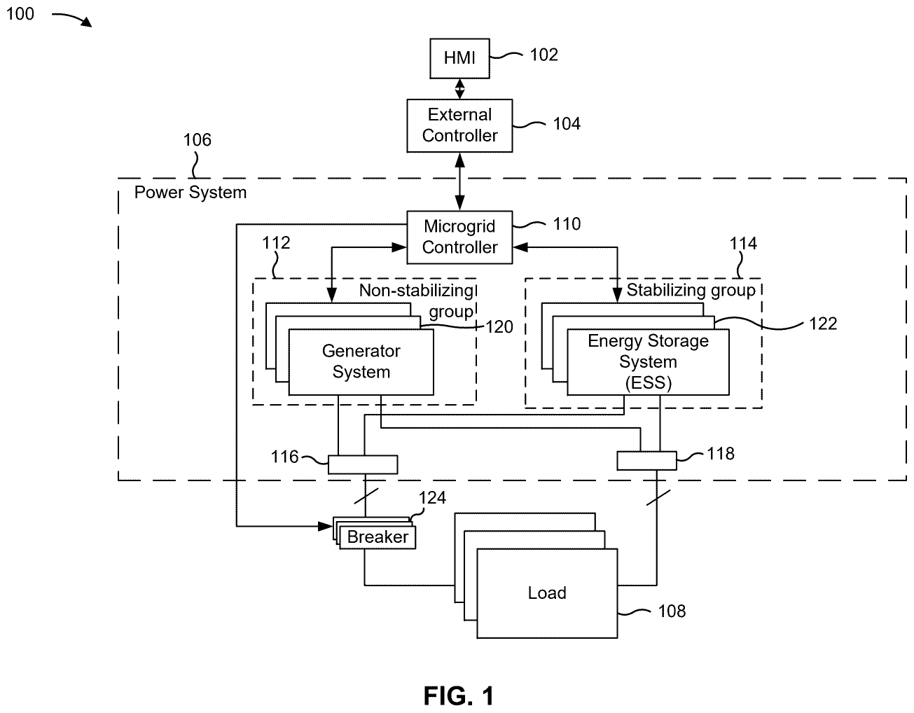

FIG. 1 shows a system 100 according to one or more implementations. The system 100 may include a human-machine interface (HMI) 102, an external controller 104, a power system 106, and one or more loads 108.

The power system 106 may be a microgrid or other type of electrical power distribution system that may provide power to the one or more loads 108. In some cases, the power system 106 may be an off-grid electrical power distribution system. In some cases, the power system 106 may be configurable to operate in a grid-connected mode and in a stand-alone mode. The power system 106 may include a microgrid controller 110, a non-stabilizing group of energy resource systems 112 (e.g., a non-stabilizing group of DERs), a stabilizing group of energy resource systems 114 (e.g., a stabilizing group of DERs), and interfaces 116 and 118. Generally, “off-grid” may mean that the electrical power distribution system is not connected to a larger electrical power distribution system run by, for example, an electric utility or other large-scale electric power generation plant that serves electricity to a geographic area, campus, compound, etc. However, techniques disclosed herein may still be applied to electrical power distribution systems that are connected to larger electrical power distribution systems. For instance, the larger electrical power distribution systems may operate as a power source in a primary provider role or secondary provider role, while the power system 106 may operate as a power source in the other of the primary provider role or secondary provider role.

The non-stabilizing group of energy resource systems 112 may include one or more energy generator systems 120. Each energy generator system 120 may include a power generator (e.g., an engine-generator, a fuel cell, a PV cell, or other power generating system) and a local generator controller communicatively coupled to the microgrid controller 110. Thus, each energy generator system 120 may generate power from a respective power source. Each local generator controller may control how much power a respective power generator generates, control a rate of power distribution, and/or obtain status information corresponding to the respective power generator. Each local generator controller may be controlled by the microgrid controller 110. The non-stabilizing group of energy resource systems 112 may be referred to as non-ESSs, non-ESS DERs, or non-ESS assets. A non-ESS may be a unidirectional non-ESS that can only supply (e.g., output) power, or may be a bidirectional non-ESS that can both supply power and absorb power. For example, an engine-generator (e.g., a generator set) may only be capable of supplying power to the power system 106, which may be provided to one or more loads 108 and/or one or more ESSs. Thus, engine-generators may be unidirectional non-ESSs. On the other hand, a fuel cell and a PV cell may be capable of supplying power to the power system 106, which may be provided to one or more loads 108 and/or one or more ESSs, and may be capable of absorbing power from the power system 106. Thus, fuel cells and PV cells may be bidirectional non-ESSs.

The stabilizing group of energy resource systems 114 may include one or more energy storage systems (ESSs) 122. Each energy storage system 122 may include an electric storage device (e.g., one or more batteries and/or capacitors) and a local ESS controller communicatively coupled to the microgrid controller 110. The stabilizing group of energy resource systems 114 may be referred to as ESSs, ESS DERs, or ESS assets. The stabilizing group of energy resource systems 114 may include different types of ESSs with different properties. For example, different types of batteries having different storage capacities, different output power, different charge rates, and different discharge rates may be provided. Each local ESS controller may control a flow of power into or out of a respective electric storage device, including charging of the respective electric storage device and discharging of the respective electric storage device, control a rate of power flow, and/or obtain status information corresponding to the respective electric storage device, such as state-of-charge (SOC), state-of-health (SOH), discharge limit, and other device parameters. Each local ESS controller may be controlled by the microgrid controller 110.

The system 100 may also include one or more breakers 124 (e.g., distribution breakers or switches) that may be individually controlled by the microgrid controller 110 to connect a respective load 108 to the power system 106 or disconnect the respective load 108 from the power system 106. The one or more breakers 124 may be part of one or both interfaces 116 and 118.

The HMI 102 may include one or more processors, and may be configured to receive and process one or more inputs from a user, such as an operator. Additionally, the HMI 102 may be configured to provide one or more prompts or outputs to the user. Thus, the HMI 102 may be a user terminal configured to interact with a user to process information and/or commands provided by the user, provide information to the user (e.g., status information), and/or perform one or more tasks or functions in response to processing the information and/or commands provided by the user. The HMI 102 may be communicatively coupled to the external controller 104, which may be communicatively coupled to the microgrid controller 110. In some implementations, the HMI 102 may be communicatively coupled directly to the microgrid controller 110. The external controller 104 may send commands to and receive information from the microgrid controller 110. For example, the external controller 104 may send commands to the microgrid controller 110 based on information received from the HMI 102. Thus, the external controller 104 may be a user-commanded controller. The external controller 104 may be integrated with the HMI 102. The external controller 104 may be a controller of a larger electrical power distribution system (e.g., a macrogrid, a power generation plant, and/or electric utility provider).

The power system 106 may provide electrical power to the one or more loads 108. Generally, the power system 106 may provide alternating current (AC) power at a particular voltage and a particular current. The microgrid controller 110 may control one or more energy storage systems 122 to instantaneously inject power when power is needed by the power system 106 or instantaneously absorb surplus power generated by the power system 106. Accordingly, one of more electric storage devices of the energy storage systems 122 may act as a power consumer on one or more energy generator systems 120 or as a power source for the one or more energy generator systems 120, to thereby ensure that system bus frequencies of the non-stabilizing group of energy resource systems 112 are maintained at a nominal value. In other words, the microgrid controller 110 may control the stabilizing group of energy resource systems 114 to stabilize loads of the non-stabilizing group of energy resource systems 112 in order to maintain the non-stabilizing group of energy resource systems 112 at a relatively constant load, which may reduce a recurrence of frequency deviations from the nominal value.

The microgrid controller 110 may be integrated with, or separate from (but connected to), the interfaces 116 and 118, the energy generator systems 120, and the energy storage systems 122, or combinations thereof. In this manner, a user may, through interaction with the HMI 102, add or remove energy generator systems 120 to increase/reduce system power generation and/or add or remove energy storage systems 122 to increase/reduce system energy storage capacity, in accordance with a user's preference. For instance, a user may prefer to add additional energy generator systems 120 and/or add additional energy storage systems 122 to increase load capacity if additional loads 108 are expected to be connected to the power system 106, or remove energy generator systems 120 and/or remove energy storage systems 122 to decrease load capacity if loads 108 are expected to be disconnected from the power system 106. Additionally, the microgrid controller 110 may be configured to add or remove energy generator systems 120 and/or add or remove energy storage systems 122 from the power system 106 based one or more conditions being satisfied. In some cases, the microgrid controller 110 may be configured to add or remove energy generator systems 120 and/or add or remove energy storage systems 122 from the power system 106 based on a schedule.

The one or more loads 108 may be any device that can connect to a power distribution system, such as the power system 106, to receive electrical power. Examples of loads may include heavy machinery (e.g., electric mining machines, haulers, etc.), personal devices, appliances, heating, ventilation, and air conditioning (HVAC) systems, industrial drills, personal residence electrical distribution systems, etc. The loads 108 may include one or more non-stable loads, such as one or more cyclic loads. The loads 108 may include unidirectional loads (e.g., loads that can only receive power from the power system 106), bi-directional loads (e.g., loads that can both receive power from the power system 106 and provide power to the power system 106), charging loads (e.g., loads that include a chargeable electric battery), essential loads (e.g., loads that require uninterrupted service), and/or non-essential loads (e.g., loads that do not require uninterrupted service). Loads may be assigned different priorities based on load type, load classification, and/or operation state or mode.

Generally, the one or more loads 108 may receive the power from the power system 106 and use the power in accordance with the operations of the one or more loads 108. Users of the power system 106 and the one or more loads 108 may connect/disconnect the one or more loads 108 by electrically connecting the one or more loads 108 to the interfaces 116 and 118 of the power system 106. For instance, the interfaces 116 and 118 may have AC plugs/sockets to connect the one or more loads 108 in parallel to the one or more energy generator systems 120 and the one or more energy storage systems 122 of the power system 106. One or more loads 108 may include a local load controller that may collect load information and transmit the load information to the microgrid controller 110. Load information may include information indicating a load type, a load classification, and/or an operation state or mode of a load 108. The loads can be active (real) or reactive to allow for a power quality-based approach to scheduling. Load information may include load data of a load, such as maximum load and minimum load. For chargeable loads, load information may include maximum charging load, maximum state of charge, minimum state of charge, current state of charge, and usable discharge energy as a function of the current state of charge. Load information may be received by the microgrid controller 110 via the interfaces 116 and 118, which may include one or more communication interfaces coupled to the microgrid controller 110.

The interfaces 116 and 118 may also have a plurality of generator connections and a plurality of energy store connections. The plurality of generator connections may be hardwired electrical connections and/or AC plugs/sockets to connect the one or more energy generator systems 120 in parallel to the at least one load 108 and the one or more energy storage systems 122. The plurality of energy store connections may be hardwired electrical connections and/or AC plugs/sockets to connect the one or more energy storage systems 122 in parallel to the one or more loads 108 and the one or more energy generator systems 120. For instance, the power system 106 may or may not allow addition/removal of energy generator systems 120 and/or addition/removal of energy storage systems 122. Therefore, depending on a configuration, the interfaces 116 and 118 may include: (1) hardwired electrical connections that connect the at least one energy generator system 120; (2) AC plugs/sockets to connect/disconnect the at least one energy generator system 120; (3) hardwired electrical connections that connect the at least one energy storage system 122; and/or (4) AC plugs/sockets to connect/disconnect the at least one energy storage system 122. The interfaces 116 and 118 may be coupled to a system bus (e.g., a power bus) of the power system 106. The system bus may enable one of more of the energy storage systems 122 to absorb power from one or more energy generator systems 120 and/or one or more loads 108 (e.g., for charging and/or storing power).

The one or more energy generator systems 120 may also include communication interfaces. The communication interfaces of the one or more energy generator systems 120 may enable the one or more energy generator systems 120 to communicate with the microgrid controller 110. For instance, the one or more energy generator systems 120 may be connected to the microgrid controller 110 by wired or wireless communication. The one or more energy generator systems 120 may provide the microgrid controller 110 with generator data (e.g., energy resource information). The generator data, for each of the one or more energy generator systems 120, may include load data and/or generator parameters. The load data may include a current (e.g., instantaneous) load seen by the one or more energy generator systems 120 and/or past load data (if one or more energy generator systems 120 store such data locally). The current load/past load data may include voltage (e.g., in volts) and/or current (e.g., in amperes) measured by one or more sensor components included in an energy generator system 120. The generator parameters may include a generator set maximum threshold value and a generator set minimum threshold value. Alternatively, to reduce transmission bandwidth, the generator data may omit the generator parameters, and the one or more energy generator systems 120 may transmit the generator parameters during an initial configuration process between the one or more energy generator systems 120 and the microgrid controller 110. The generator set maximum threshold value and the generator set minimum threshold value may indicate a maximum power load and a minimum power load, respectively, that a generator of an energy generator system 120 may support.

The one or more energy storage systems 122 may be any energy storage device that can store and output AC power. For instance, the one or more energy storage systems 122 may include at least one electrical-chemical energy storage (e.g., a battery), electrical energy storage (e.g., a capacitor, a supercapacitor, or a superconducting magnetic energy storage), mechanical energy storage (e.g., a fly wheel, a pump system), and/or any combination thereof. The one or more energy storage systems 122 may include inverters (individually or collectively) so that the one or more energy storage systems 122 may operate as a power consumer or a power source.

The one or more energy storage systems 122 may also include electronic control mechanisms to control (1) how much load the one or more energy storage systems 122 draw, or (2) how much AC power the one or more energy storage systems 122 output.

The one or more energy storage systems 122 may also include communication interfaces. The communication interfaces of the one or more energy generator systems 120 may enable the one or more energy storage systems 122 to communicate with the microgrid controller 110. For instance, the one or more energy storage systems 122 may be connected to the microgrid controller 110 by wired or wireless communication. The one or more energy storage systems 122 may provide the microgrid controller 110 with energy storage data (e.g., energy resource information) and may receive instructions from the microgrid controller 110.

The energy storage data may include, for each of the at least one energy store, a current energy level (e.g., kilowatt-hours currently stored), total energy storage capacity (e.g., kilowatt-hours of capacity), and/or discharge/charge parameters. The current energy level may be measured by a battery meter of an energy storage. The battery meter may one or combinations of a voltmeter, an amp-hour meter, and/or an impedance-based meter. The discharge/charge parameters may indicate an amount of discharge power and an amount of charge power for a respective energy storage device of the one or more energy storage systems 122. Alternatively, to reduce transmission bandwidth, the energy storage data may omit the discharge/charge parameters, and the one or more energy storage systems 122 may transmit the discharge/charge parameters when the one or more energy storage systems 122 are first connected to the microgrid controller 110.

The one or more energy storage systems 122 may receive requests (e.g., instructions) for the energy storage data to provide the energy storage data and/or continuously provide the energy storage data to the microgrid controller 110. The instructions may include energy storage dispatch (ESD) instructions. An ESD instruction may include an instruction to inject power to a system bus of the power system 106 or absorb power from the system bus of the power system 106. ESD instructions may be provided in control signals (e.g., communication signals that provide the ESD instructions). At least one ESD instruction may be utilized to rapidly stabilize the load, thereby stabilizing the bus frequency of the power system 106 in a time efficient manner, rather than attempting to stabilize the load using the one or more energy generator systems 120 alone. The one or more energy storage systems 122 may control the inverters and the electronic control mechanisms to control (1) quantity of load drawn by the one or more energy storage systems 122, or (2) the amount of AC power output produced by the one or more energy storage systems 122, in accordance with the ESD instructions. Reactive and/or active may be used as a qualifier for loads, where reactive loads may contribute to a stabilization algorithm in addition to the active or real loads.

The microgrid controller 110 may include at least one memory device (e.g., one or more memories) for storing instructions (e.g., program code); at least one processor for executing the instructions from the memory device to perform a set of desired operations; and a communication interface (e.g., coupled to a communication bus) for facilitating the communication between various system components. The instructions may be computer-readable instructions for executing a control application. The communication interface of the microgrid controller 110 may enable the microgrid controller 110 to communicate with the one or more energy generator systems 120 and the one or more energy storage systems 122. The microgrid controller 110, while executing the control application, may receive the generator data and the energy storage data (e.g., energy resource information), process the generator data and the energy storage data to generate one or more ESD instructions, and output the ESD instructions to one or more energy generator systems 120 and/or to one or more energy storage systems 122.

To process the generator data and the energy storage data to generate the ESD instructions, the control application may include a load stabilization function and/or a state-of-charge (SOC) function. The control application may also include a generator set limit function and/or energy store discharge/charge limit function to generate the ESD instruction. In some cases, the load stabilization function may be activated while the power system 106 is configured in stand-alone mode in order to provide off-grid load stabilization. The microgrid controller 110 may automatically activate or deactivate the aforementioned system functions based on presence or absence of systems parameters (such as no generator set minimum threshold value is available, etc.) or one or more system conditions being satisfied.

The microgrid controller 110 may execute a command strategy for commanding and dispatching the energy resource systems to perform load balancing, charging/discharging of ESS type assets according to charge restrictions, and exporting to bidirectional non-ESS and utility type assets according to export restrictions. Thus, the microgrid controller 110 may execute the command strategy for dispatching unidirectional and bidirectional assets with restrictions to perform a sequence of dispatch operations in accordance with a prioritization dispatch scheme.

The microgrid controller 110 may adapt the command strategy for dispatching energy resource assets based on charge restrictions placed on any of the non-ESS assets and/or export restrictions placed on any energy resource asset (e.g., non-ESS asset or ESS asset). A charge restriction may be placed on a non-ESS asset when the non-ESS asset is not permitted to charge a particular ESS asset or a group of ESS assets. Moreover, each non-ESS asset may have a different set of charge restrictions, such that each charge restriction may be linked to a different ESS asset or a different group of ESS assets. An export restriction may be placed on a non-ESS asset or an ESS asset when the non-ESS asset or the ESS asset is not permitted to export power to a particular bidirectional non-ESS asset.

The microgrid controller 110 may perform at least one dispatch operation selected from a load balance dispatch operation, an export dispatch operation, or a charge/discharge dispatch operation according to a prioritization dispatch scheme. For example, the load balance dispatch operation, the export dispatch operation, and the charge/discharge dispatch operation may be assigned different dispatch priorities that define a sequence of dispatch operations of the prioritization dispatch scheme. The different dispatch priorities may be assigned by an operator via the HMI 102 or by a prioritization schedule. In some examples, the load balance dispatch operation may always be included in the prioritization dispatch scheme. In some examples, the microgrid controller 110 may perform at least two dispatch operations according to the prioritization dispatch scheme.

During the load balance dispatch operation, the microgrid controller 110 may distribute a total load or a portion of the total load among a plurality of non-ESSs. The communication interface of the microgrid controller 110 may receive load information corresponding to a current load demand of the loads 108 connected to the microgrid and output one or more control signals (e.g., ESD instructions) for controlling a plurality of energy resource systems associated with the microgrid. The plurality of energy resource systems may include the non-stabilizing group of energy resource systems 112 and the stabilizing group of energy resource systems 114. During the export dispatch operation, the microgrid controller 110 may export power from at least one non-ESS and/or at least one ESS to at least one bidirectional non-ESS based on any export restrictions placed on the non-ESSs and/or the ESSs. During the charge/discharge dispatch operation, the microgrid controller 110 may charge or discharge one or more ESSs based on any charge restrictions placed on the non-ESSs.

Generally, the load stabilization function may ensure that system bus frequencies of the one or more energy generator systems 120 are maintained at a nominal value by causing an amount of power to be absorbed/injected by the one or more energy storage systems 122. The amount of power may be determined based on a difference from an instantaneous load and a moving average of the load. Meanwhile, the SOC function may ensure that the one or more energy storage systems 122 are charged to a target SOC or a target SOC range such that a SOC of one or more energy storage systems does not drift too low or too high, outside of a desired operating range (e.g., the target SOC range). The target SOC or the target SOC range may enable the at least one energy storage system 122 to provide long term beneficial use to the system 100, such as having a range of operation usable by the power system 106 and/or avoid degradation ranges of the one or more energy storage systems 122.

Furthermore, the systems and methods of the present disclosure may check the ESD instruction against acceptable generator maximum/minimum loads of the one or more energy generator systems 120 and the discharge/charge limits of the one or more energy storage systems 122, so as to safely operate the one or more energy generator systems 120.

One or more energy generator systems 120 may include an engine-generator that provides AC power to the power system 106, which may provide the AC power to the at least one load 108. Generally, an engine-generator may be any device that converts motive power (mechanical energy) into electrical power to output the AC power. An engine-generator may be a gas turbine electrical generator. In such gas turbine electrical generators, fast changes in load from the at least one load 108 may cause a system bus frequency to deviate from a nominal value. The system bus frequency may be a frequency of electrical components of the generator. For instance, such gas turbine electrical generators may have isochronous frequency control governors that may try to maintain the system bus frequency to the nominal value in response to changes of the load of the one or more loads 108. Therefore, during a transient load charge (e.g., a load transient), the system bus frequency may change as the load on the engine-generator changes. However, a rate of return of the system bus frequency back to the nominal value is slower than a desired rate due to an inertia of motion of physical components (e.g., a rotor of a stator-rotor) of the engine-generator. The slow rate of return may reduce power quality of the power system 106. The power quality of the power system 106 may be determined based on the voltage, frequency, and waveform of the power output to the one or more loads 108. A high power quality may ensure continuity of service for the one or more loads 108, such that the one or more loads 108 are able to properly function as intended. A low power quality may cause the one or more loads 108 to malfunction, fail prematurely, or not operate at all.

Therefore, avoiding load transients may be beneficial in providing better power quality. However, generally, controlling a load of the one or more loads 108 may not be possible or desirable. Instead, the microgrid controller 110 may control the one or more energy storage systems 122 of the stabilizing group of energy resource systems 114 to act as a power consumer or as an energy source, so that the one or more energy generator systems 120 of the non-stabilizing group of energy resource systems 112 may maintain the system bus frequency at the nominal value, thereby ensuring better power quality.

The microgrid controller 110 may control the one or more energy storage systems 122 to act as a near instantaneous load or energy source, so that the one or more energy generator systems 120 may maintain the system bus frequency at the nominal value, thereby ensuring better power quality. In one aspect of this disclosure, the microgrid controller 110 may control the one or more energy storage systems 122 to instantaneously inject power when power is needed by the at least one load 108 or instantaneously absorb surplus power generated by the one or more energy generator systems 120. Accordingly, the microgrid controller 110 regulates the power supply such that an exact amount of desired power supply flows in or out of the power system 106 at any given time. The instantaneous injecting/absorbing power may be performed to control the amount of transient load seen by the power system 106 and thus stabilize the load and resulting system bus frequency of the one or more energy generator systems 120. The desired power may be calculated by performing a moving average of a system load and then taking a difference of the moving average and an instantaneous load value. This difference may be the desired power output/absorbed of the energy store. Causing the one or more energy storage systems 122 to output/absorb the desired power (e.g., by transmitting the energy storage dispatch instructions) may limit the transient load seen by the one or more energy generator systems 120.

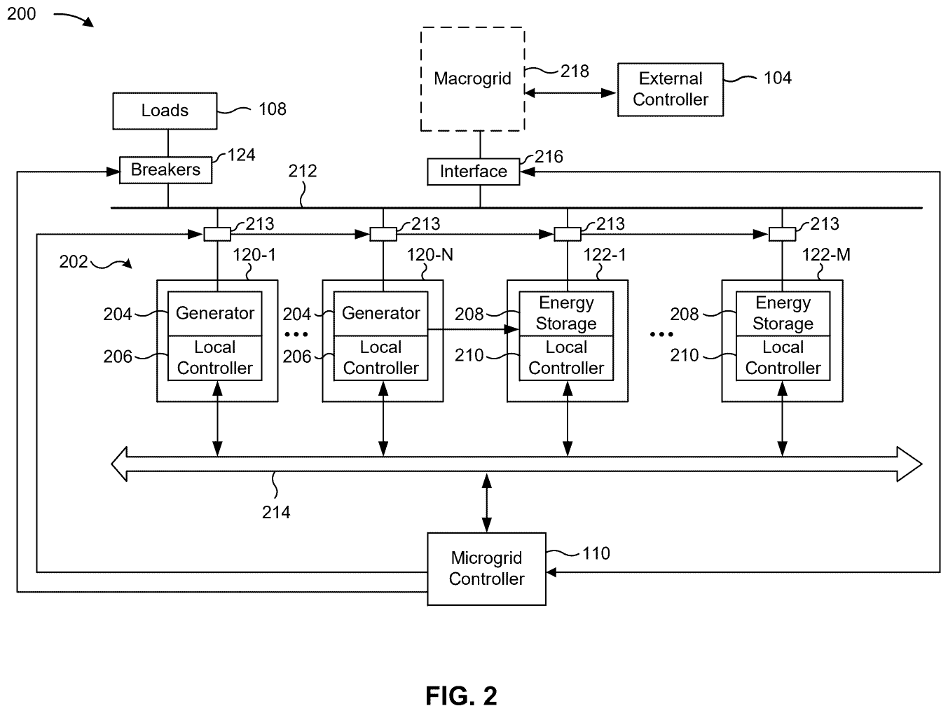

FIG. 2 shows a microgrid 200 according to one or more implementations. The microgrid 200 may be an example of the power system 106 described in connection with FIG. 1. The microgrid 200 may include a plurality of DERs 202. The plurality of DERs 202 may include N energy generator systems 120 and M energy storage systems 122, where N and M are integers greater than zero. For example, the plurality of DERs 202 may include a first energy generator system 120-1 and an N^{th} energy generator system 120-N. Additionally, the plurality of DERs 202 may include a first energy storage system 122-1 and an M^{th} energy storage system 122-M. Each energy generator system 120 may include a power generator 204 and a local generator controller 206. Each energy storage system 122 may include an electric storage device 208 (e.g., one or more batteries and/or capacitors) and a local ESS controller 210.

Each energy generator system 120 may be coupled to a power bus 212 for providing power to one or more loads connected to the power bus 212. Additionally, each energy storage system 122 may be coupled to the power bus 212 for providing power to or absorbing power from the power bus 212 (e.g., for providing power to or absorbing power from one or more components, such as one or more loads and/or one or more energy generator systems 120 connected to the power bus 212).

The microgrid 200 may also include the microgrid controller 110 that is communicatively coupled to the local controllers (e.g., local generator controllers 206 and local ESS controllers 210) of each DER 202 across a communication bus 214. The communication bus 214 may also enable the microgrid 200 to communicate with one or more loads and/or one or more load management systems (e.g., charging systems, fleet management systems, local load controllers, etc.). In some cases, two or more communication buses 214 may be provided. For example, one communication bus may be provided to communicate with local controllers and another communication bus may be provided to communicate with one or more loads and/or one or more load management systems.

Each local generator controller 206 may include any appropriate hardware, software, and/or firmware to sense and control a respective power generator 204, and send information to, and receive information, from microgrid controller 110. For example, a local generator controller 206 may be configured to sense, determine, and/or store generator data of its respective power generator 204. The generator data may be sensed, determined, and/or stored in any conventional manner. Each local generator controller 206 may control whether a respective power generator 204 is connected to or disconnected from the power bus 212 (for example, based on an instruction or a control signal received from the microgrid controller 110).

Each local ESS controller 210 may include any appropriate hardware, software, and/or firmware to sense and control a respective electric storage device 208, and send information to, and receive information, from microgrid controller 110. For example, a local ESS controller 210 may be configured to sense, determine, and/or store various characteristics of its respective electric storage device 208. Such characteristics of the respective electric storage device 208 may include, among others, a current SOC, a current energy, an SOC minimum threshold, an SOC maximum threshold, and a discharge limit of the respective electric storage device 208. These characteristics of each respective electric storage device 208 may be sensed, determined, and/or stored in any conventional manner. Each local ESS controller 210 may control whether a respective electric storage device 208 is connected to or disconnected from the power bus 212 (for example, based on an instruction or a control signal received from the microgrid controller 110).

The microgrid controller 110 may receive or determine a need for charging or discharging of power from the microgrid 200, and may be configured to determine and send signals to allocate a total charge request and/or total discharge request across all of the plurality of DERs 202.

When performing the power allocation functions, the microgrid controller 110 may allocate a certain amount of power from each energy generator system 120 to one or more loads 108. The one or more loads 108 may be connected to the power bus 212 via one or more breakers 124 to receive power from the power bus. When performing the power allocation functions, the microgrid controller 110 may allocate a total charge request and/or a total discharge request across the energy storage systems 122 as a function of a usable energy capacity of each energy storage system 122. The usable energy capacity corresponds to the capacity or amount of energy that an energy storage system 122 can receive in response to a total charging request (usable charge energy), or the capacity or amount of energy that an energy storage system can discharge in response to a total discharge request (usable discharge energy). The usable charge energy is a function of a maximum state of charge, current state of charge, and current energy of the energy storage system, and the usable discharge energy is a function of a minimum state of charge, and current energy of the energy storage system 122. The microgrid controller 110 may determine a usable charge/discharge capacity of each energy storage system 122 (e.g., SOC), a desired charge/discharge of each energy storage system 122, a remainder power of each energy storage system 122, and/or an SOH of each energy storage system 122.

Thus, the microgrid controller 110 regulates a power supply of the microgrid 200 such that an exact amount of desired power flows into or out of the power system 106 at any given time. The microgrid controller 110 may regulate the power supply of the microgrid 200 in cooperation with the local generator controllers 206 and the local ESS controllers 210. The microgrid controller 110 may transmit control signals (e.g., instructions) to the local generator controllers 206 and the local ESS controllers 210 to activate (e.g., to bring online), deactivate (to bring offline), or curtail (limit or regulate to a target output) one or more of the DERs 202. Additionally, or alternatively, the microgrid controller 110 may transmit control signals to one or more switches 213 to control a switch state (e.g., an on state or an off state) of the one or more switches 213, for example, to connect one or more DERs 202 to or disconnect one or more DERs 202 from the microgrid 200 (e.g., the power bus 212). The switches 213 may be integrated in one or both interfaces 116 and 118 described in connection with FIG. 1.

In some cases, two or more power buses 212 may be provided. For example, a power bus may be provided to couple one or more power generators 204 to one or more electric storage devices 208 for charging the one or more electric storage devices 208. For example, the microgrid controller 110 may selectively couple a power generator 204 to an electric storage device 208 to charge the electric storage device 208. Thus, the power bus 212 may be part of a power distribution network of the microgrid 200 that may include one or more power buses used to distribute power between loads 108 and/or DERs 202.

The microgrid 200 may include an interface 216 for connecting the microgrid 200 to and disconnecting the microgrid 200 from an electrical power distribution system 218, such as a macrogrid. The electrical power distribution system 218 may include the external controller 104 (e.g., a macrogrid controller), as described in connection with FIG. 1. The external controller 104 may be coupled to the interface 216 for transmitting control signals, such as instructions or requests, to the microgrid controller 110. The interface 216 may include one or more electrical connections used for connecting the microgrid 200 to the electrical power distribution system 218. The interface 216 may include one or more switches or breakers that are controlled by the microgrid controller 110 for connecting the microgrid 200 to and disconnecting the microgrid 200 from the electrical power distribution system 218. For example, the one or more switches or breakers of the interface 216 may connect the power bus 212 (or another system bus) to or disconnect the power bus 212 (or another system bus) from the electrical power distribution system 218. Thus, the microgrid controller 110 may configure the microgrid 200 to operate in a grid-connected mode by connecting the microgrid 200 to the electrical power distribution system 218 or in a stand-alone mode by disconnecting the microgrid 200 from the electrical power distribution system 218.

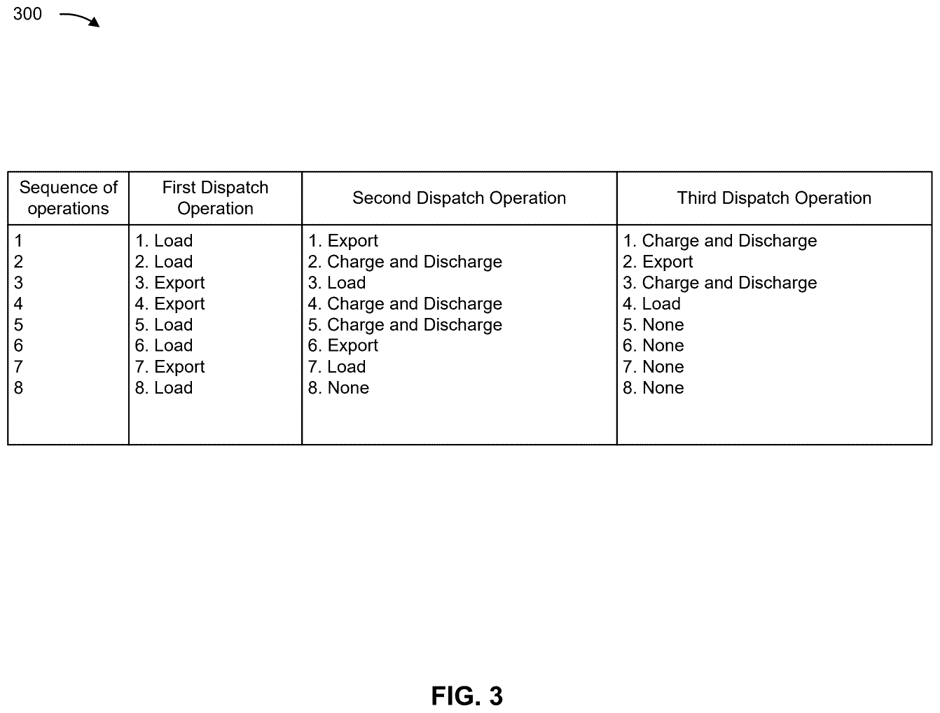

FIG. 3 shows a table 300 showing different prioritization dispatch schemes, each having a different sequence of dispatch operations. A first dispatch operation may correspond to a highest priority and may result in a first group dispatch (e.g., dispatch 1). A second dispatch operation may correspond to a second priority and may result in a second group dispatch (e.g., dispatch 2), which may take the first group dispatch into account. The third dispatch operation may correspond to a third (lowest) priority and may result in a third group dispatch (e.g., dispatch 3), which may take the first group dispatch and/or the second group dispatch into account.

During the load balance dispatch operation, the microgrid controller 110 may distribute a total load or a portion of the total load (e.g., a remaining portion of the total load if performed after a discharge dispatch operation) among all individual non-ESS assets (e.g., non-ESSs) based on priority and operating levels (e.g., from highest priority to lowest priority). An operating level may be a power level (e.g., a kilowatt (kW) value) at which a non-ESS asset can operate or produce. In some examples, the operating level may be a percentage of a power rating of a non-ESS asset, which may translate into a kW value. If the load balance dispatch operation is performed in the second dispatch operation or the third dispatch operation, the total load or a portion of the total load may be distributed among all individual non-ESS assets in addition to the dispatch operation that is performed in the first dispatch operation or the second dispatch operation, respectively.

In some examples, the microgrid controller 110 may, for the load balance dispatch operation, evaluate priority information defining priority levels for a plurality of non-ESSs, where each non-ESS is assigned a different priority level. Additionally, the microgrid controller 110 may evaluate a respective power operating level for each non-ESS. Additionally, the microgrid controller 110 may calculate a total load based on the load information. Additionally, the microgrid controller 110 may distribute the total load among the plurality of non-ESSs based on the priority levels and respective power operating levels of the plurality of non-ESSs such that the plurality of non-ESSs are dispatched from a highest priority level to a lowest priority level in accordance with the respective power operating levels. For example, a first non-ESS may have a highest priority and a 50 kW operating level, a second non-ESS may have a second priority and a 100 kW operating level, a third non-ESS may have a third priority and a 75 kW operating level, and so on. The microgrid controller 110 may dispatch the non-ESSs in order of priority until the total load is satisfied by the respective operating levels. This dispatch may be referred to as a group dispatch or an aggregated non-ESS dispatch. In some cases, the respective operating levels of the plurality of non-ESSs may be sufficient to satisfy the total demand, or may even result in an excess or surplus in available output power. In some cases, the respective operating levels of the plurality of non-ESSs may be insufficient to satisfy the total demand, resulting in a shortfall or power deficit.

During the charge/discharge dispatch operation, the microgrid controller 110 may determine to charge ESS assets by respective charge quantity (e.g., a charge kW quantity), or discharge the ESS assets by a respective discharge quantity (e.g., a discharge kW quantity) based on various parameters, such as current SOC, total load, export, non-ESS dispatches, and/or charge restrictions. The discharge kW quantity may be allocated from the ESS assets to the loads 108 and/or bidirectional non-ESS assets.

Based on a charge kW quantity, the microgrid controller 110 may evaluate an aggregated non-ESS dispatch to distribute the charge kW quantity among non-ESS assets to the ESS assets based on priority and operating levels of the non-ESS assets (e.g., from highest priority or remaining highest priority to lowest priority) and charge restrictions. Based on charge restrictions, if any non-ESS asset is not allowed to charge, then distribution of charge from the non-ESS asset to a particular ESS asset can be zero or retained with a previous dispatch of that non-ESS asset, which may be assigned in a first dispatch operation or a second dispatch operation. The charge kW quantity may be distributed among non-ESS assets that are allowed to charge in addition to the aggregated non-ESS dispatch that may have been determined in the first dispatch operation and/or the second dispatch operation. In other words, additional non-ESS dispatches may be added to the aggregated non-ESS dispatch based on the ESS assets acting as sinks.

Additionally, based on a discharge kW quantity, the microgrid controller 110 may evaluate an aggregated non-ESS dispatch to distribute the discharge kW quantity among non-ESS assets irrespective of charge restrictions. Put another way, an aggregated non-ESS dispatch may be adjusted to take the discharge kW quantity into account. For example, allocations to non-ESS may be subtracted, reduced, or removed from the aggregated non-ESS dispatch due to power being suppled (discharged) by the ESS assets. In other words, some dispatches may no longer be needed or may be reduced based on the ESS assets acting as sources.

In some examples, the microgrid controller 110 may, for the charge/discharge dispatch operation, evaluate priority information defining priority levels for the plurality of non-ESSs. Additionally, the microgrid controller 110 may evaluate a respective power operating level for each non-ESS. Additionally, the microgrid controller 110 may evaluate a current SOC of each ESS, determine whether each ESS should be charged or discharged, and determine a respective charge quantity or a respective discharge quantity for each ESS based on the current SOC of each ESS. Additionally, the microgrid controller 110 may evaluate one or more charge restrictions placed on the plurality of non-ESSs, and distribute output power to each ESS to be charged from the plurality of non-ESSs based on the priority levels, respective power operating levels, and the one or more charge restrictions, such that the plurality of non-ESSs are dispatched from a highest priority level to a lowest priority level to satisfy the respective charge quantity of each ESS to be charged. Additionally, the microgrid controller 110 may distribute output power from each ESS to be discharged to the microgrid. In some examples, the current SOC may be for a group of ESSs and the group of ESS may be charged or discharged collectively, taking into account any charge restrictions for charging.

During the export dispatch operation, the microgrid controller 110 may distribute an export power quantity (e.g., an export kW quantity) among all individual non-ESS assets based on priority (e.g., from highest priority or remaining highest priority to lowest priority), operating levels, and export restrictions. Based on export restrictions, if any non-ESS asset is not allowed to export, then distribution of export power from the non-ESS asset to a particular bidirectional non-ESS asset can be zero or retained with a previous dispatch of the non-ESS asset, which may be assigned in a first dispatch operation or a second dispatch operation. The export kW quantity may be distributed among non-ESS assets that are allowed to export, in addition to any aggregated non-ESS dispatch determined in the first dispatch operation and/or the second dispatch operation.

In some examples, the microgrid controller 110 may, for the export dispatch operation, evaluate priority information defining priority levels for the plurality of non-ESSs, evaluate a respective power operating level for each non-ESS, and determine, based on the energy resource information, an export power quantity to be received by a bidirectional non-ESS. Additionally, the microgrid controller 110 may evaluate one or more export restrictions placed on the plurality of non-ESSs (unidirectional and bidirectional ESS assets). A non-ESS having an export restriction to a particular bidirectional non-ESS is excluded from exporting power to the particular bidirectional non-ESS. Additionally, the microgrid controller 110 may export output power to the bidirectional non-ESS from the plurality of non-ESSs based on the priority levels, respective power operating levels, and the one or more export restrictions, such that the plurality of non-ESSs are dispatched from a highest priority level to a lowest priority level to export power to the bidirectional non-ESS to satisfy the export power quantity.

In some examples, the microgrid controller 110 may, for the export dispatch operation, evaluate one or more export restrictions placed on the plurality of unidirectional non-ESSs, where a unidirectional non-ESS having an export restriction to a particular bidirectional non-ESS is excluded from exporting power to the particular bidirectional non-ESS. Additionally, the microgrid controller 110 may export output power to the bidirectional non-ESS from the plurality of unidirectional non-ESSs based on the priority levels, respective power operating levels, and the one or more export restrictions, such that the plurality of unidirectional non-ESSs are dispatched from a highest priority level to a lowest priority level to export power to the bidirectional non-ESS to satisfy the export power quantity.

In some examples, the microgrid controller 110 may, for the export dispatch operation, evaluate one or more export restrictions placed on the plurality of ESSs, where an ESS having an export restriction to a particular bidirectional non-ESS is excluded from exporting power to the particular bidirectional non-ESS. Additionally, the microgrid controller 110 may export output power to the bidirectional non-ESS from the plurality of ESSs based on the priority levels, respective power operating levels, and the one or more export restrictions such that the plurality of ESSs are dispatched from a highest priority level to a lowest priority level to export power to the bidirectional non-ESS to satisfy the export power quantity.

After evaluating various inputs, such as a sequence of dispatch operations, charge restrictions, export restrictions, load, current SOC, and various operating levels of each asset, the microgrid controller 110 may evaluate the different asset type dispatches at each dispatch operation stage. After performing the sequence of dispatch operations, the microgrid controller 110 may perform a final dispatch operation to finalize dispatches and dispatch commands. The final dispatch of assets can be reevaluated according to the operations described below.

A final dispatch of unidirectional non-ESS assets Ax may be defined by the last dispatch operation that dispatched the unidirectional non-ESS assets Ax.

Bidirectional non-ESS assets Ay may be configured to operate within certain import and export limits. Based on a specific sequence of dispatch operations, the microgrid controller 110 may use bidirectional non-ESS assets Ay to supply power to the loads 108, charge ESS assets, and/or import (absorb) power from non-ESS assets or from ESS assets. Thus, a final dispatch of bidirectional non-ESS assets Ay may be equal to a dispatch of bidirectional non-ESS assets Ay provided in a last dispatch operation minus a distributed export power quantity (e.g., a power quantity imported to the bidirectional non-ESS assets Ay.

A final dispatch of ESS assets Az may be determined by the dispatch determined during the charge/discharge dispatch operation.

A grid forming asset Ag may have a final dispatch equal to the total load minus (Ax+Ay+Az).

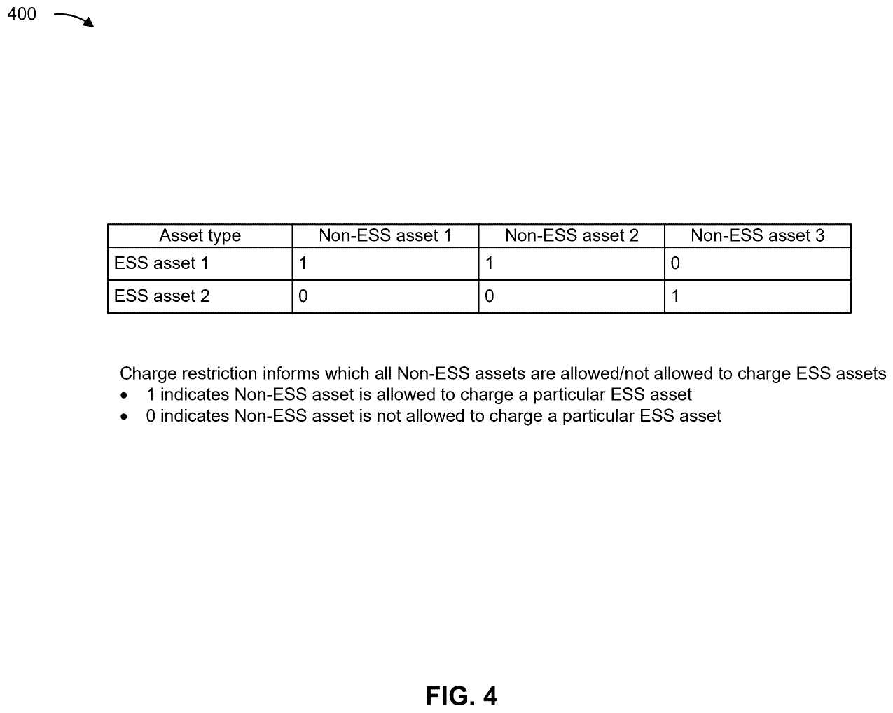

FIG. 4 shows a control table 400 for charge restrictions. A non-ESS asset may have a charge restriction enabled for a particular ESS asset. For example, a binary value 0 may indicate that the non-ESS asset is allowed to charge the particular ESS asset, whereas a binary value 1 may indicate that the non-ESS asset is not allowed to charge the particular ESS asset. In other words, a binary value in the control table 400 may indicate whether a charge restriction for a particular ESS asset is enabled or disabled. For example, non-ESS asset 1 may be permitted to charge ESS asset 1, non-ESS asset 2 may be permitted to charge ESS asset 1, and non-ESS asset 3 may be permitted to charge ESS asset 2. The microgrid controller 110 may store the control table 400 in memory and evaluate the control table 400 for determining charge restrictions during the charge/discharge dispatch operation.

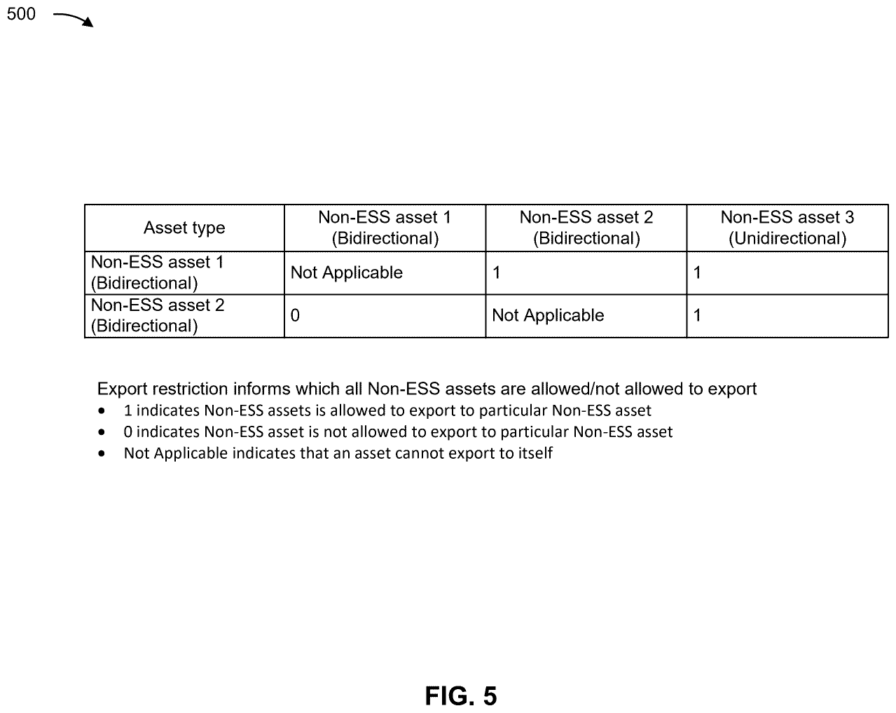

FIG. 5 shows a control table 500 for export restrictions. A non-ESS asset may have an export restriction enabled for a particular bidirectional non-ESS asset, except for itself. For example, a binary value 0 may indicate that the non-ESS asset is not allowed to export to the particular bidirectional non-ESS asset, whereas a binary value 1 may indicate that the non-ESS asset is allowed to export to the particular bidirectional non-ESS asset. In other words, a binary value in the control table 500 may indicate whether an export restriction for a particular bidirectional non-ESS asset is enabled or disabled. For example, non-ESS asset 1 may not be permitted to export power to non-ESS asset 2, non-ESS asset 2 may be permitted to export power to non-ESS asset 1, and non-ESS asset 3 may be permitted to export power to non-ESS asset 1 and non-ESS asset 2. The microgrid controller 110 may store the control table 500 in memory and evaluate the control table 500 for determining export restrictions during the export dispatch operation.

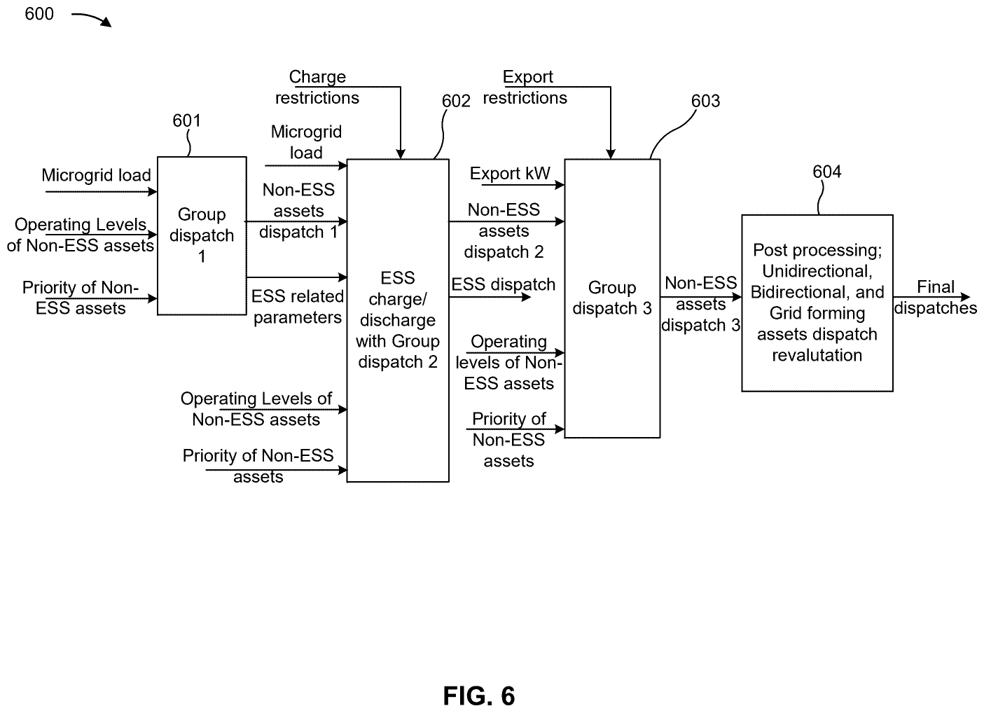

FIG. 6 shows a processing system 600 of a microgrid controller configured for performing a sequence of dispatch operations. The processing system 600 may be a processing system of the microgrid controller 110 and may comprise one or more processors. The processing system 600 may include a first processing module 601, a second processing module 602, a third processing module 603, and a fourth processing module 604. The first processing module 601, the second processing module 602, the third processing module 603, and the fourth processing module 604 may be realized by one or more processors. In other words, the first processing module 601, the second processing module 602, the third processing module 603, and the fourth processing module 604 may be part of a same processor or may be realized by a distributed group of processors.

The sequence of dispatch operations includes first performing a load balance dispatch operation, followed by performing a charge/discharge dispatch operation, followed by performing an export dispatch operation, followed by performing a final dispatch operation. The sequence of dispatch operations shown in FIG. 6 is merely an example. The processing modules 601-604 may be configured to perform any of the sequence of dispatch operations described elsewhere herein. The load balance dispatch operation may be performed by the first processing module 601 of the microgrid controller 110 that corresponds to a first group dispatch. The charge/discharge dispatch operation may be performed by the second processing module 602 of the microgrid controller 110 that corresponds to a second group dispatch. The export dispatch operation may be performed by the third processing module 603 of the microgrid controller 110 that corresponds to a third group dispatch. The final dispatch operation may be performed by the fourth processing module 604 of the microgrid controller 110 that corresponds to a final group dispatch.

The first processing module 601 may receive a microgrid load (e.g., a total load), operating levels of non-ESS assets, and priority levels of the non-ESS assets. The first processing module 601 may perform the load balance dispatch operation to determine a first non-ESS asset dispatch (dispatch 1).

The second processing module 602 may receive the microgrid load (e.g., the total load), the operating levels of the non-ESS assets, the priority levels of the non-ESS assets, charge restrictions, dispatch 1, and ESS-related parameters, such as SOC and charge limits. The second processing module 602 may perform the charge/discharge dispatch operation to determine a second non-ESS asset dispatch (dispatch 2) and an ESS dispatch. The second processing module 602 may generate the second non-ESS asset dispatch (dispatch 2) by revising the first non-ESS asset dispatch (dispatch 1) based on the charge/discharge dispatch operation.

The third processing module 603 may receive the operating levels of the non-ESS assets, the priority levels of the non-ESS assets, export restrictions, dispatch 2, and an export power quantity. The third processing module 603 may perform the export dispatch operation to determine a third non-ESS asset dispatch (dispatch 3). The third processing module 603 may generate the third non-ESS asset dispatch (dispatch 3) by revising the second non-ESS asset dispatch (dispatch 2) based on the export dispatch operation.

The fourth processing module 604 may receive the third non-ESS asset dispatch (dispatch 3) and perform post-processing and dispatch reevaluation to determine the final dispatch of the non-ESS assets.

In some examples, a sequence of dispatch operations may include first performing the load balance dispatch operation, followed by performing the charge/discharge dispatch operation. For the load balance dispatch operation, the microgrid controller 110 may evaluate priority information defining priority levels for the plurality of non-ESSs, evaluate a respective power operating level for each non-ESS, calculate a total load based on the load information, and distribute the total load among the plurality of non-ESSs based on the priority levels and respective power operating levels such that the plurality of non-ESSs are dispatched from a highest priority level to a lowest priority level.

For the charge/discharge dispatch operation, the microgrid controller 110 may determine whether a power deficit or a power surplus relative to the total load exists based on a dispatch of the plurality of non-ESSs from the load balance dispatch operation. If a power deficit exists, the microgrid controller 110 may distribute the power deficit among the plurality of ESSs such that at least one ESS of the plurality of ESSs is discharged to cover the power deficit. If a power surplus exists, the microgrid controller 110 may distribute output power corresponding to the power surplus to each ESS to be charged from the plurality of non-ESSs based on the priority levels, the respective power operating levels, and one or more charge restrictions such that the plurality of non-ESSs are dispatched from a highest remaining priority level to the lowest priority level to satisfy a respective charge quantity of each ESS to be charged.

In some examples, a sequence of dispatch operations may include first performing the load balance dispatch operation, followed by performing the charge/discharge dispatch operation. For the load balance dispatch operation, the microgrid controller 110 may evaluate priority information defining priority levels for the plurality of non-ESSs, wherein each non-ESS is assigned a different priority level, evaluate a respective power operating level for each non-ESS, calculate a total load based on the load information, and distribute the total load among the plurality of non-ESSs based on the priority levels and respective power operating levels such that the plurality of non-ESSs are dispatched from a highest priority level to a lowest priority level. For the charge/discharge dispatch operation, the microgrid controller 110 may evaluate a current SOC of each ESS, determine whether each ESS should be charged or discharged and a respective charge quantity or a respective discharge quantity for each ESS based on the current SOC of each ESS, the total load, and an amount of output power dispatched from the plurality of non-ESSs during the load balance dispatch operation, evaluate one or more charge restrictions placed on the plurality of non-ESSs, wherein a non-ESS having a charge restriction to a particular ESS is excluded from charging the particular ESS, distribute output power to each ESS to be charged from the plurality of non-ESSs based on the priority levels, the respective power operating levels, and the one or more charge restrictions such that the plurality of non-ESSs are dispatched from a highest remaining priority level to the lowest priority level to satisfy the respective charge quantity of each ESS to be charged, and distribute output power from each ESS to be discharged to the microgrid.

Additionally, the sequence of dispatch operations may include performing the export dispatch operation after performing the charge/discharge dispatch operation. For the export dispatch operation, the microgrid controller 110 may determine, based on the energy resource information, an export power quantity to be received by a bidirectional non-ESS, evaluate one or more export restrictions placed on the plurality of non-ESSs, wherein a non-ESS having an export restriction to a particular bidirectional non-ESS is excluded from exporting power to the particular bidirectional non-ESS, and export output power to the bidirectional non-ESS from the plurality of non-ESSs based on the priority levels, the respective power operating levels, and the one or more export restrictions such that the plurality of non-ESSs are dispatched from a highest remaining priority level to the lowest priority level to export power to the bidirectional non-ESS to satisfy the export power quantity.

In some examples, a sequence of dispatch operations may include first performing the load balance dispatch operation, followed by performing the export dispatch operation. For the load balance dispatch operation, the microgrid controller 110 may evaluate priority information defining priority levels for the plurality of non-ESSs, wherein each non-ESS is assigned a different priority level, evaluate a respective power operating level for each non-ESS, calculate a total load based on the load information, and distribute the total load among the plurality of non-ESSs based on the priority levels and respective power operating levels such that the plurality of non-ESSs are dispatched from a highest priority level to a lowest priority level. For the export dispatch operation, the microgrid controller 110 may determine, based on the energy resource information, an export power quantity to be received by a bidirectional non-ESS, evaluate one or more export restrictions placed on the plurality of non-ESSs, wherein a non-ESS having an export restriction to a particular bidirectional non-ESS is excluded from exporting power to the particular bidirectional non-ESS, and export output power to the bidirectional non-ESS from the plurality of non-ESSs based on the priority levels, the respective power operating levels, and the one or more export restrictions such that the plurality of non-ESSs are dispatched from the highest priority level to the lowest priority level to export power to the bidirectional non-ESS to satisfy the export power quantity.

Additionally, the sequence of dispatch operations may include performing the charge/discharge dispatch operation after performing the export dispatch operation. For the charge/discharge dispatch operation, the microgrid controller 110 may evaluate a current SOC of each ESS, determine whether each ESS should be charged or discharged and a respective charge quantity or a respective discharge quantity for each ESS based on the current SOC of each ESS, the total load, an amount of output power dispatched from the plurality of non-ESSs during the load balance dispatch operation, and an amount of output power dispatched from the plurality of non-ESSs during the export dispatch operation, evaluate one or more charge restrictions placed on the plurality of non-ESSs, wherein a non-ESS having a charge restriction to a particular ESS is excluded from charging the particular ESS, distribute output power to each ESS to be charged from the plurality of non-ESSs based on the priority levels, the respective power operating levels, and the one or more charge restrictions such that the plurality of non-ESSs are dispatched from a highest remaining priority level to the lowest priority level to satisfy the respective charge quantity of each ESS to be charged, and distribute output power from each ESS to be discharged to the microgrid.

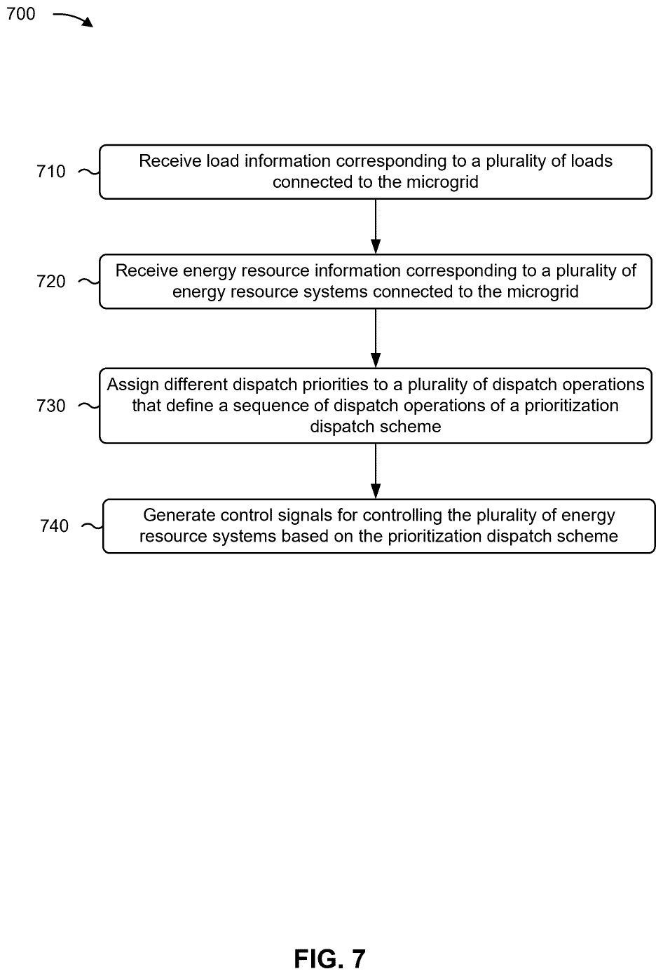

FIG. 7 is a flowchart of an example process 700 associated with microgrid command strategy. One or more process blocks of FIG. 7 may be performed by a microgrid controller (e.g., microgrid controller 110). Additionally, or alternatively, one or more process blocks of FIG. 7 may be performed by another device or a group of devices separate from or including the microgrid controller, such as another device or component that is internal or external to the microgrid controller 110. For example, an HMI (e.g., HMI 102) may be configured to provide one or more parameters to the microgrid controller 110. For example, the HMI 102 may provide priorities, operating levels, charge restrictions for one or more non-ESS assets, export restrictions for one or more non-ESS assets, charge limits, discharge limits, and/or import restrictions to the microgrid controller 110.

As shown in FIG. 7, process 700 may include receiving load information of a plurality of loads connected to the microgrid (710). The load information may correspond to a of loads 108. For example, the microgrid controller 110 may receive the load information corresponding to loads 108 connected to the microgrid, as described above.

As further shown in FIG. 7, process 700 may include receiving energy resource information corresponding to a plurality of energy resource systems connected to the microgrid (720). The plurality of energy resource systems (e.g., DERs 202) may include a plurality of ESSs configured to be charged and discharged, and a plurality of non-ESSs, including a plurality of unidirectional non-ESSs configured to supply power to the microgrid, and a plurality of bidirectional non-ESSs configured to supply power to the microgrid or absorb power from the microgrid. For example, the microgrid controller 110 may receive the energy resource information corresponding to a plurality of energy resource systems connected to the microgrid, as described above.

As further shown in FIG. 7, process 700 may include assigning different dispatch priorities to a plurality of dispatch operations that define a sequence of dispatch operations of a prioritization dispatch scheme (730). The plurality of dispatch operations may include at least two dispatch operations selected from a load balance dispatch operation, an export dispatch operation, or a charge/discharge dispatch operation. The load balance dispatch operation, the export dispatch operation, and the charge/discharge dispatch operation may be assigned the different dispatch priorities that define the sequence of dispatch operations of the prioritization dispatch scheme. For example, the microgrid controller 110 may assign different dispatch priorities to a plurality of dispatch operations that define a sequence of dispatch operations of a prioritization dispatch scheme, as described above.

As further shown in FIG. 7, process 700 may include generating control signals for controlling the plurality of energy resource systems based on the prioritization dispatch scheme (740). For example, the microgrid controller 110 may generate control signals for controlling the plurality of energy resource systems based on the prioritization dispatch scheme, as described above.

In some implementations, process 700 includes, during the load balance dispatch operation, distributing a total load or a portion of the total load among the plurality of unidirectional non-ESSs, during the export dispatch operation, exporting power from at least one non-ESS or from at least one ESS to at least one bidirectional non-ESS based on any export restrictions placed on the plurality of non-ESSs and the plurality of ESSs, and, during the charge/discharge dispatch operation, charging or discharging the plurality of ESSs based on any charge restrictions placed on the plurality of non-ESSs.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

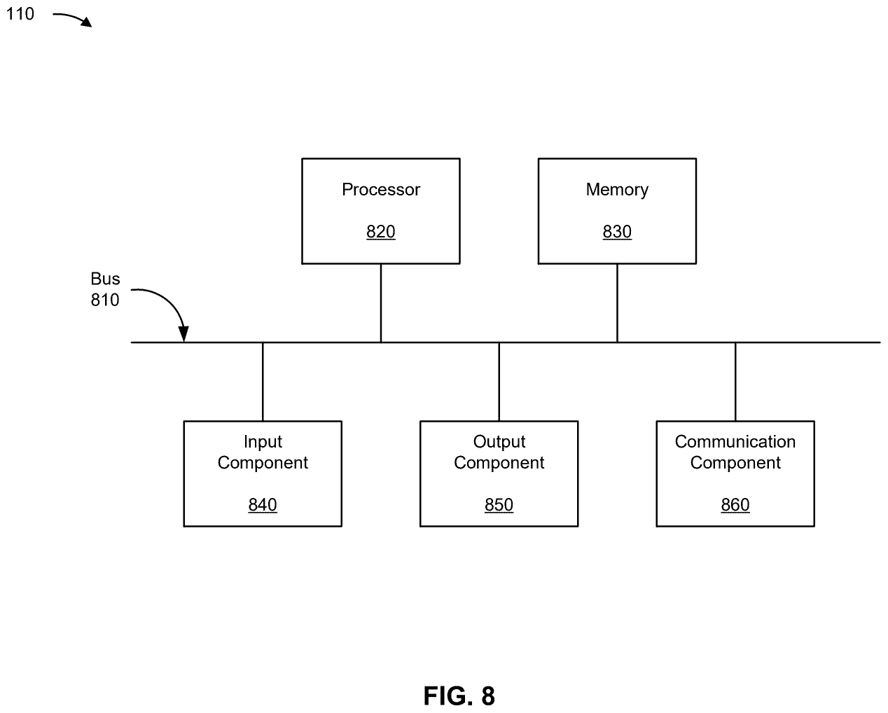

FIG. 8 is a diagram of example components of the microgrid controller 110 associated with a microgrid command strategy. The microgrid controller 110 may include a bus 810, a processor 820, a memory 830, an input component 840, an output component 850, and/or a communication component 860.

The bus 810 may include one or more components that enable wired and/or wireless communication among the components of the microgrid controller 110. The bus 810 may couple together two or more components of FIG. 8, such as via operative coupling, communicative coupling, electronic coupling, and/or electric coupling. For example, the bus 810 may include an electrical connection (e.g., a wire, a trace, and/or a lead) and/or a wireless bus.

The processor 820 may include a central processing unit a microprocessor, a controller, a microcontroller, a digital signal processor, a field-programmable gate array, an application-specific integrated circuit, and/or another type of processing component. The processor 820 may be implemented in hardware, firmware, or a combination of hardware and software. The processor 820 may include one or more processors capable of being programmed to perform one or more operations or processes described elsewhere herein.

The memory 830 may store information, one or more instructions, and/or software (e.g., one or more software applications) related to the operation of the microgrid controller 110. The memory 830 may include one or more memories that are coupled (e.g., communicatively coupled) to one or more processors (e.g., processor 820), such as via the bus 810.

Communicative coupling between a processor 820 and a memory 830 may enable the processor 820 to read and/or process information stored in the memory 830 and/or to store information in the memory 830.

The input component 840 may enable the microgrid controller 110 to receive input, load information, generator data, energy storage data, status information, scheduling information, and/or control signals (e.g., control signals from a macrogrid controller). The output component 850 may enable the microgrid controller 110 to provide output, such as one or more control signals for controlling loads, energy storage systems, breakers, switches, and other components associated with the microgrid described herein. The communication component 860 may enable the microgrid controller 110 to communicate with other devices via a wired connection and/or a wireless connection. For example, the communication component 860 may include a receiver, a transmitter, and/or a transceiver.

The microgrid controller 110 may perform one or more operations or processes described herein. For example, a non-transitory computer-readable medium (e.g., memory 830) may store a set of instructions (e.g., one or more instructions or code) for execution by the processor 820. The processor 820 may execute the set of instructions to perform one or more operations or processes described herein. Execution of the set of instructions, by one or more processors 820, may cause the one or more processors 820 and/or the microgrid controller 110 to perform one or more operations or processes described herein. Hardwired circuitry may be used instead of or in combination with the instructions to perform one or more operations or processes described herein. Additionally, or alternatively, the processor 820 may be configured to perform one or more operations or processes described herein. Thus, implementations described herein are not limited to any specific combination of hardware circuitry and software.

### Industrial Applicability

A microgrid control dispatch strategy described herein may be compatible with a power management scheme that is based on a user-defined sequence of load, export, and charging priorities; charge restrictions and hybrid charge restrictions on power sources (non-ESS type) to feed power sources (ESS type); and export restrictions and hybrid export restrictions on power sources (non-ESS or ESS type) to feed bidirectional power sources (non-ESS type).

What is claimed is:

1. A microgrid controller of a microgrid, comprising:
a communication interface configured to receive load information corresponding to a plurality of loads connected to the microgrid, receive energy resource information corresponding to a plurality of energy resource systems connected to the microgrid, and output control signals for controlling an operation of each energy resource system of the plurality of energy resource systems, wherein the plurality of energy resource systems includes a plurality of energy storage systems (ESSs) configured to be charged and discharged, and a plurality of non-ESSs, including a plurality of unidirectional non-ESSs configured to supply power to the microgrid, and a plurality of bidirectional non-ESSs configured to supply power to the microgrid or absorb power from the microgrid; and
one or more processors configured to perform at least two dispatch operations selected from a load balance dispatch operation, an export dispatch operation, or a charge/discharge dispatch operation according to a prioritization dispatch scheme,
wherein the load balance dispatch operation, the export dispatch operation, and the charge/discharge dispatch operation are assigned different dispatch priorities that define a sequence of dispatch operations of the prioritization dispatch scheme.

2. The microgrid controller of claim 1, wherein the one or more processors are configured to, during the load balance dispatch operation, distribute a total load or a portion of the total load among the plurality of unidirectional non-ESSs,
wherein the one or more processors are configured to, during the export dispatch operation, export power from at least one non-ESS or from at least one ESS to at least one bidirectional non-ESS based on any export restrictions placed on the plurality of non-ESSs and the plurality of ESSs, and
wherein the one or more processors are configured to, during the charge/discharge dispatch operation, charge or discharge the plurality of ESSs based on any charge restrictions placed on the plurality of non-ESSs.

3. The microgrid controller of claim 1, wherein, for the load balance dispatch operation, the one or more processors are configured to:
evaluate priority information defining priority levels for the plurality of non-ESSs, wherein each non-ESS is assigned a different priority level,
evaluate a respective power operating level for each non-ESS,
calculate a total load based on the load information, and
distribute the total load among the plurality of non-ESSs based on the priority levels and respective power operating levels of the plurality of non-ESSs such that the plurality of non-ESSs are dispatched from a highest priority level to a lowest priority level in accordance with the respective power operating levels.

4. The microgrid controller of claim 1, wherein, for the charge/discharge dispatch operation, the one or more processors are configured to:
evaluate priority information defining priority levels for the plurality of non-ESSs, wherein each non-ESS is assigned a different priority level,
evaluate a respective power operating level for each non-ESS,
evaluate a current state-of-charge (SOC) of each ESS,
determine whether each ESS should be charged or discharged and a respective charge quantity or a respective discharge quantity for each ESS based on the current SOC of each ESS,
evaluate one or more charge restrictions placed on the plurality of non-ESSs, wherein a non-ESS having a charge restriction to a particular ESS is excluded from charging the particular ESS,
distribute output power to each ESS to be charged from the plurality of non-ESSs based on the priority levels, respective power operating levels, and the one or more charge restrictions such that the plurality of non-ESSs are dispatched from a highest priority level to a lowest priority level to satisfy the respective charge quantity of each ESS to be charged, and
distribute output power from each ESS to be discharged to the microgrid.

5. The microgrid controller of claim 1, wherein, for the export dispatch operation, the one or more processors are configured to:
evaluate priority information defining priority levels for the plurality of non-ESSs, wherein each non-ESS is assigned a different priority level,
evaluate a respective power operating level for each non-ESS,
determine, based on the energy resource information, an export power quantity to be received by a bidirectional non-ESS,
evaluate one or more export restrictions placed on the plurality of non-ESSs, wherein a non-ESS having an export restriction to a particular bidirectional non-ESS is excluded from exporting power to the particular bidirectional non-ESS, and
export output power to the bidirectional non-ESS from the plurality of non-ESSs based on the priority levels, respective power operating levels, and the one or more export restrictions such that the plurality of non-ESSs are dispatched from a highest priority level to a lowest priority level to export power to the bidirectional non-ESS to satisfy the export power quantity.

6. The microgrid controller of claim 1, wherein, for the export dispatch operation, the one or more processors are configured to:
evaluate priority information defining priority levels for the plurality of unidirectional non-ESSs, wherein each unidirectional non-ESS is assigned a different priority level,
evaluate a respective power operating level for each unidirectional non-ESS,
determine, based on the energy resource information, an export power quantity to be received by a bidirectional non-ESS,
evaluate one or more export restrictions placed on the plurality of unidirectional non-ESSs, wherein a unidirectional non-ESS having an export restriction to a particular bidirectional non-ESS is excluded from exporting power to the particular bidirectional non-ESS, and
export output power to the bidirectional non-ESS from the plurality of unidirectional non-ESSs based on the priority levels, respective power operating levels, and the one or more export restrictions such that the plurality of unidirectional non-ESSs are dispatched from a highest priority level to a lowest priority level to export power to the bidirectional non-ESS to satisfy the export power quantity.

7. The microgrid controller of claim 1, wherein the sequence of dispatch operations includes first performing the load balance dispatch operation followed by performing the charge/discharge dispatch operation,
wherein, for the load balance dispatch operation, the one or more processors are configured to:
evaluate priority information defining priority levels for the plurality of non-ESSs, wherein each non-ESS is assigned a different priority level,
evaluate a respective power operating level for each non-ESS,
calculate a total load based on the load information, and
distribute the total load among the plurality of non-ESSs based on the priority levels and respective power operating levels such that the plurality of non-ESSs are dispatched from a highest priority level to a lowest priority level,
wherein, for the charge/discharge dispatch operation, the one or more processors are configured to:
determine whether a power deficit or a power surplus relative to the total load exists based on a dispatch of the plurality of non-ESSs from the load balance dispatch operation,
if a power deficit exists, distribute the power deficit among the plurality of ESSs such that at least one ESS of the plurality of ESSs is discharged to cover the power deficit, and
if a power surplus exists, distribute output power corresponding to the power surplus to each ESS to be charged from the plurality of non-ESSs based on the priority levels, the respective power operating levels, and one or more charge restrictions such that the plurality of non-ESSs are dispatched from a highest remaining priority level to the lowest priority level to satisfy a respective charge quantity of each ESS to be charged.

8. The microgrid controller of claim 1, wherein the sequence of dispatch operations includes first performing the load balance dispatch operation followed by performing the charge/discharge dispatch operation,
wherein, for the load balance dispatch operation, the one or more processors are configured to:
evaluate priority information defining priority levels for the plurality of non-ESSs, wherein each non-ESS is assigned a different priority level,
evaluate a respective power operating level for each non-ESS,
calculate a total load based on the load information, and
distribute the total load among the plurality of non-ESSs based on the priority levels and respective power operating levels such that the plurality of non-ESSs are dispatched from a highest priority level to a lowest priority level,
wherein, for the charge/discharge dispatch operation, the one or more processors are configured to:
evaluate a current state-of-charge (SOC) of each ESS,
determine whether each ESS should be charged or discharged and a respective charge quantity or a respective discharge quantity for each ESS based on the current SOC of each ESS, the total load, and an amount of output power dispatched from the plurality of non-ESSs during the load balance dispatch operation,
evaluate one or more charge restrictions placed on the plurality of non-ESSs, wherein a non-ESS having a charge restriction to a particular ESS is excluded from charging the particular ESS,
distribute output power to each ESS to be charged from the plurality of non-ESSs based on the priority levels, the respective power operating levels, and the one or more charge restrictions such that the plurality of non-ESSs are dispatched from a highest remaining priority level to the lowest priority level to satisfy the respective charge quantity of each ESS to be charged, and
distribute output power from each ESS to be discharged to the microgrid.

9. The microgrid controller of claim 8, wherein the sequence of dispatch operations includes performing the export dispatch operation after performing the charge/discharge dispatch operation,
wherein, for the export dispatch operation, the one or more processors are configured to:
determine, based on the energy resource information, an export power quantity to be received by a bidirectional non-ESS,
evaluate one or more export restrictions placed on the plurality of non-ESSs, wherein a non-ESS having an export restriction to a particular bidirectional non-ESS is excluded from exporting power to the particular bidirectional non-ESS, and
export output power to the bidirectional non-ESS from the plurality of non-ESSs based on the priority levels, the respective power operating levels, and the one or more export restrictions such that the plurality of non-ESSs are dispatched from a highest remaining priority level to the lowest priority level to export power to the bidirectional non-ESS to satisfy the export power quantity.

10. The microgrid controller of claim 1, wherein the sequence of dispatch operations includes first performing the load balance dispatch operation followed by performing the export dispatch operation.

11. The microgrid controller of claim 10, wherein the sequence of dispatch operations includes performing the charge/discharge dispatch operation after performing the export dispatch operation.

12. The microgrid controller of claim 1, wherein the sequence of dispatch operations includes first performing the export dispatch operation followed by performing the load balance dispatch operation.

13. The microgrid controller of claim 12, wherein the sequence of dispatch operations includes performing the charge/discharge dispatch operation after performing the load balance dispatch operation.

14. The microgrid controller of claim 1, wherein the sequence of dispatch operations includes first performing the export dispatch operation followed by performing the charge/discharge dispatch operation.

15. The microgrid controller of claim 14, wherein the sequence of dispatch operations includes performing the load balance dispatch operation after performing the charge/discharge dispatch operation.

16. The microgrid controller of claim 1, wherein the sequence of dispatch operations includes first performing the load balance dispatch operation followed by performing the export dispatch operation,
wherein, for the load balance dispatch operation, the one or more processors are configured to:
evaluate priority information defining priority levels for the plurality of non-ESSs, wherein each non-ESS is assigned a different priority level,
evaluate a respective power operating level for each non-ESS,
calculate a total load based on the load information, and
distribute the total load among the plurality of non-ESSs based on the priority levels and respective power operating levels such that the plurality of non-ESSs are dispatched from a highest priority level to a lowest priority level, and
wherein, for the export dispatch operation, the one or more processors are configured to:
determine, based on the energy resource information, an export power quantity to be received by a bidirectional non-ESS,
evaluate one or more export restrictions placed on the plurality of non-ESSs, wherein a non-ESS having an export restriction to a particular bidirectional non-ESS is excluded from exporting power to the particular bidirectional non-ESS, and
export output power to the bidirectional non-ESS from the plurality of non-ESSs based on the priority levels, the respective power operating levels, and the one or more export restrictions such that the plurality of non-ESSs are dispatched from the highest priority level to the lowest priority level to export power to the bidirectional non-ESS to satisfy the export power quantity.

17. The microgrid controller of claim 16, wherein the sequence of dispatch operations includes performing the charge/discharge dispatch operation after performing the export dispatch operation,
wherein, for the charge/discharge dispatch operation, the one or more processors are configured to:
evaluate a current state-of-charge (SOC) of each ESS,
determine whether each ESS should be charged or discharged and a respective charge quantity or a respective discharge quantity for each ESS based on the current SOC of each ESS, the total load, an amount of output power dispatched from the plurality of non-ESSs during the load balance dispatch operation, and an amount of output power dispatched from the plurality of non-ESSs during the export dispatch operation,
evaluate one or more charge restrictions placed on the plurality of non-ESSs, wherein a non-ESS having a charge restriction to a particular ESS is excluded from charging the particular ESS,
distribute output power to each ESS to be charged from the plurality of non-ESSs based on the priority levels, the respective power operating levels, and the one or more charge restrictions such that the plurality of non-ESSs are dispatched from a highest remaining priority level to the lowest priority level to satisfy the respective charge quantity of each ESS to be charged, and
distribute output power from each ESS to be discharged to the microgrid.

18. A microgrid controller of a microgrid, comprising:
a communication interface configured to receive load information corresponding to a plurality of loads connected to the microgrid, receive energy resource information corresponding to a plurality of energy resource systems connected to the microgrid, and output control signals for controlling an operation of each energy resource system of the plurality of energy resource systems, wherein the plurality of energy resource systems includes a plurality of energy storage systems (ESSs) configured to be charged and discharged, and a plurality of non-ESSs, including a plurality of unidirectional non-ESSs configured to supply power to the microgrid, and a plurality of bidirectional non-ESSs configured to supply power to the microgrid or absorb power from the microgrid; and
one or more processors configured to perform at least one dispatch operation, including a load balance dispatch operation, wherein performing the load balance dispatch operation includes:
evaluating priority information defining priority levels for the plurality of non-ESSs, wherein each non-ESS is assigned a different priority level,
evaluating a respective power operating level for each non-ESS,
calculating a total load or a remaining total load based on the load information, and
distributing the total load or a remaining total load among the plurality of non-ESSs based on the priority levels and respective power operating levels of the plurality of non-ESSs such that the plurality of non-ESSs are dispatched from a highest priority level to a lowest priority level in accordance with the respective power operating levels.

19. A control method, comprising:
receiving, by a microgrid controller of a microgrid, load information corresponding to a plurality of loads connected to the microgrid;
receiving, by the microgrid controller, energy resource information corresponding to a plurality of energy resource systems connected to the microgrid, wherein the plurality of energy resource systems includes a plurality of energy storage systems (ESSs) configured to be charged and discharged, and a plurality of non-ESSs, including a plurality of unidirectional non-ESSs configured to supply power to the microgrid, and a plurality of bidirectional non-ESSs configured to supply power to the microgrid or absorb power from the microgrid;
assigning, by the microgrid controller, different dispatch priorities to a plurality of dispatch operations that define a sequence of dispatch operations of a prioritization dispatch scheme; wherein the plurality of dispatch operations include at least two dispatch operations selected from a load balance dispatch operation, an export dispatch operation, or a charge/discharge dispatch operation,
wherein the load balance dispatch operation, the export dispatch operation, and the charge/discharge dispatch operation are assigned the different dispatch priorities that define the sequence of dispatch operations of the prioritization dispatch scheme; and
generating, by the microgrid controller, control signals for controlling the plurality of energy resource systems based on the prioritization dispatch scheme.

20. The control method of claim 19, wherein:
during the load balance dispatch operation, distributing a total load or a portion of the total load among the plurality of unidirectional non-ESSs,
during the export dispatch operation, exporting power from at least one non-ESS or from at least one ESS to at least one bidirectional non-ESS based on any export restrictions placed on the plurality of non-ESSs and the plurality of ESSs, and
during the charge/discharge dispatch operation, charging or discharging the plurality of ESSs based on any charge restrictions placed on the plurality of non-ESSs.
